(19) United States
(12) Patent Application Publication
(10) Pub. No.: US 2026/0204029 A1
(43) Pub. Date: Jul. 16, 2026

(54) INFORMATION PROCESSING SYSTEM, INFORMATION PROCESSING METHOD, AND PROGRAM

(71) Applicant: Sony Interactive Entertainment Inc., Tokyo (JP)

(72) Inventors: Yasushi Okumura, Tokyo (JP); Katsuhiko Matsuura, Tokyo (JP)

(73) Assignee: Sony Interactive Entertainment Inc., Tokyo (JP)

(21) Appl. No.: 19/559,824

(22) Filed: Mar. 6, 2026

Related U.S. Application Data
(63) Continuation of application No. PCT/JP2023/035431, filed on Sep. 28, 2023.

(51) Int. Cl. G06T 19/00; G06T 7/73; G06V 10/774; G06V 20/20; G06V 40/10

(52) U.S. Cl. CPC G06T 19/006; G06T 7/73; G06V 20/20; G06T 2207/20081; G06T 2207/30196; G06V 10/774; G06V 40/11

(57) ABSTRACT

It is made easy to hold a real object on which a virtual item is superimposed. An information processing system estimates the position and pose of a real object from a captured image of the real object (S101), draws a virtual item to be superimposed on the real object, on the basis of the estimated position and pose (S107), and acquires information indicating a portion of the item to be superimposed on a portion of the real object capable of being held (S103). The information processing system changes a display mode of the portion to be superimposed that is indicated by the information (S106, S107).

### TECHNICAL FIELD

The present invention relates to an information processing system, an information processing method, and a program.

### BACKGROUND ART

There is a technology that estimates a position and a pose of a real object from a captured image of the object.

Sida Peng et al. have presented a paper “PVNet: Pixel-Wise Voting Network for 6DoF Pose Estimation” in 2019 IEEE/CVF CVPR (Conference on Computer Vision and Pattern Recognition). In this paper, disclosed is a technique of training a machine learning model with training data including an input image generated from a 3D (Three-Dimensional) model and a ground truth output image and further estimating a pose of an object on the basis of output when a captured image is input to the machine learning model.

### SUMMARY

### Technical Problem

The inventors have examined application of the technology of estimating a pose of an object to VR (Virtual Reality) or MR (Mixed Reality) to allow a user to use a real object actually being held by the user to operate a virtual item superimposed at a position of the object. In this case, the superimposed item usually does not match in shape the real object. Therefore, it may be difficult for the user to hold the object to be used for operation.

The present invention has been made in view of the above circumstances, and an object thereof is to provide a technology that makes it easy to hold a real object on which a virtual item is superimposed.

### Solution to Problem

In order to solve the above-mentioned problem, an information processing system according to the present invention includes one or more processors, and the one or more processors estimate a position and a pose of a real object from a captured image of the real object, draw a virtual item to be superimposed on the real object, on the basis of the estimated position and pose, and change, in the drawing, a display mode of a portion of the item to be superimposed on a portion of the real object capable of being held.

In an embodiment of the present invention, the one or more processors may draw a 3D image of the virtual item to be superimposed on the real object, on the basis of the estimated position and pose and a 3D shape model of the item.

In an embodiment of the present invention, the one or more processors may determine whether or not a user holds the real object, and restore the display mode of the portion to be superimposed to its original state in a case of determining that the user holds the real object.

In an embodiment of the present invention, the one or more processors may change the display mode of the portion to be superimposed, on the basis of a distance between a user and the item.

In an embodiment of the present invention, the one or more processors may make the display mode of the portion to be superimposed different from a display mode of another portion in a case where the distance between the user and the item is equal to or less than a determination threshold.

In an embodiment of the present invention, the one or more processors may draw the item in such a manner that the portion to be superimposed is illuminated.

In an embodiment of the present invention, the one or more processors may draw the item in such a manner that transmittance of the portion to be superimposed is greater than transmittance of another portion.

In an embodiment of the present invention, in a case where a distance between a user and the item is more than a drawing threshold, the one or more processors may not draw the item or may set transmittance of the item greater than transmittance of the item in a case where the distance is equal to or less than the drawing threshold.

In an embodiment of the present invention, the one or more processors may draw the item in such a manner that a shape of the portion to be superimposed corresponds to a shape of the real object.

In addition, an information processing method according to the present invention includes, by one or more processors, estimating a position and a pose of a real object from a captured image of the real object, drawing a virtual item to be superimposed on the real object, on the basis of the estimated position and pose, acquiring information indicating a portion of the item to be superimposed on a portion of the real object capable of being held, and changing, in the drawing, a display mode of the portion to be superimposed that is indicated by the information.

Moreover, a program according to the present invention causes a computer to function as estimation means configured to estimate a position and a pose of a real object from a captured image of the real object, drawing means configured to draw a virtual item to be superimposed on the real object, on the basis of the estimated position and pose, and portion acquisition means configured to acquire information indicating a portion of the item to be superimposed on a portion of the real object capable of being held. The drawing means changes a display mode of the portion to be superimposed that is indicated by the information.

### ADVANTAGEOUS EFFECTS OF INVENTION

According to the present invention, it becomes possible to easily hold a real object on which a virtual item is superimposed.

### BRIEF DESCRIPTION OF DRAWINGS

FIG. 1 is a diagram illustrating an example of a configuration of an information processing system according to an embodiment of the present invention.

FIG. 2 is a block diagram illustrating an example of functions implemented in the information processing system according to the embodiment of the present invention.

FIG. 3 is a flowchart illustrating an example of a process of drawing a virtual item corresponding to an object.

FIG. 4 is a diagram illustrating an example of a captured image.

FIG. 5 is a diagram for explaining the object and a grip portion thereof.

FIG. 6 is a diagram for explaining drawing of a grip portion of the virtual item.

FIG. 7 is a diagram for explaining the virtual item after the object is held.

FIG. 8 is a flowchart illustrating an example of a process for associating the object with the virtual item.

FIG. 9 is a diagram illustrating an example of an object protruding from the virtual item.

FIG. 10 is a diagram illustrating an example of a changed shape of the virtual item.

FIG. 11 is a flowchart illustrating another example of the process of drawing the virtual item corresponding to the object.

FIG. 12 is a diagram for explaining the virtual item that is reduced in size before the object is held.

### DESCRIPTION OF EMBODIMENT

An embodiment of the present invention will be described in detail below on the basis of the drawings.

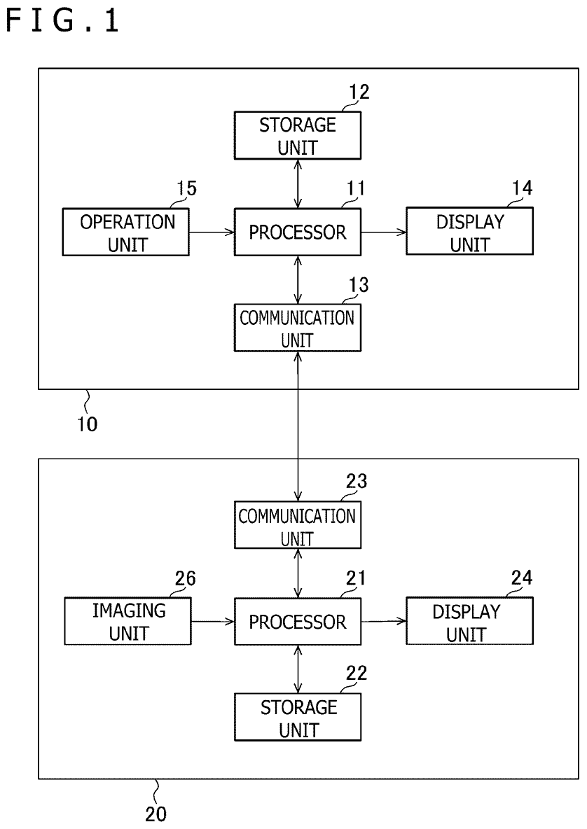

FIG. 1 is a diagram illustrating an example of a configuration of an information processing system according to the embodiment of the present invention. The information processing system according to the present embodiment includes an information processing apparatus 10 and a VR device 20. The information processing apparatus 10 is, for example, a computer such as a game console or a personal computer. The VR device 20 is equipment including a display device and an imaging device, such as a VR headset or a head-mounted display. In the information processing system, the information processing apparatus 10 and the VR device 20 may be integrated with each other.

As illustrated in FIG. 1, the information processing apparatus 10 includes, for example, a processor 11, a storage unit 12, a communication unit 13, a display unit 14, and an operation unit 15. The VR device 20 includes a processor 21, a storage unit 22, a communication unit 23, a display unit 24, and an imaging unit 26.

The processors 11 and 21 are program control devices such as CPUs (Central Processing Units) or GPUs (Graphics Processing Units). For example, the processors 11 and 21 operate according to a program installed in the information processing apparatus 10 and a program installed in the VR device 20, respectively.

The storage units 12 and 22 include at least part of a memory device such as a ROM (Read-Only Memory) or a RAM (Random-Access Memory) or an external storage device such as a solid-state drive. The storage units 12 and 22 store, for example, a program to be executed by the processor 11 and a program to be executed by the processor 21, respectively.

The communication units 13 and 23 are, for example, wired or wireless communication interfaces such as network interface cards and exchange data with another computer or device through a computer network such as the Internet.

The display units 14 and 24 are display devices such as liquid-crystal displays and display various images according to instructions from the processor 11 and instructions from the processor 21, respectively. The display unit 14 may also be a device that outputs a video signal to an external display device.

The operation unit 15 is, for example, an input device such as a keyboard, a mouse, a touch screen, or a controller of a game console. The operation unit 15 receives an operation input by a user and outputs a signal indicating contents of the operation to the processor 11

The imaging unit 26 is an imaging device including an image sensor. The imaging unit 26 may be a camera capable of acquiring a visible RGB (Red, Green, and Blue) image. The imaging unit 26 may also be a camera capable of acquiring a visible RGB image and depth information synchronized to the visible RGB image. The imaging unit 26 according to the present embodiment may be a camera capable of capturing a moving image, for example. The imaging unit 26 may be provided outside the VR device 20 and the information processing apparatus 10. In this case, the imaging unit 26 may be connected to the information processing apparatus 10 or the VR device 20 via the communication unit 13 or 23

Incidentally, the information processing apparatus 10 and the VR device 20 may also include audio input/output devices such as microphones or loudspeakers. In addition, the information processing apparatus 10 may also include, for example, a communication interface such as a network board, an optical disc drive that reads an optical disc such as a DVD (Digital Versatile Disc)-ROM or a Blu-ray (registered trademark) disc, and an input/output unit (USB (Universal Serial Bus) port) for inputting and outputting data to and from external equipment

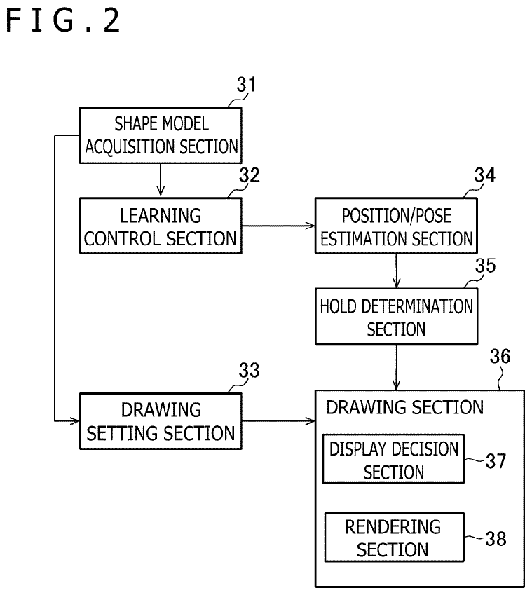

FIG. 2 is a block diagram illustrating an example of functions implemented in the information processing system according to the embodiment of the present invention. As illustrated in FIG. 2, the information processing system functionally includes a shape model acquisition section 31, a learning control section 32, a drawing setting section 33, a position/pose estimation section 34, a hold determination section 35, and a drawing section 36. The drawing section 36 functionally includes a display decision section 37 and a superimposed drawing section 38.

At least some of these functions may be implemented mainly by the processor 11 and the storage unit 12 of the information processing apparatus 10. More specifically, these functions may be implemented when the processor 11 executes programs that are installed in the information processing apparatus 10 and that include execution commands corresponding to these functions. At least some of these functions may be implemented mainly by the processor 21 and the storage unit 22 of the VR device 20. Further, at least some of these functions may be implemented by the information processing apparatus 10 and the VR device 20 operating in cooperation with each other. Specifically, these functions may be implemented when the information processing apparatus 10 and the VR device 20 cause the processors 11 and 21, respectively, to execute programs that are installed in the information processing apparatus 10 and the VR device 20 and that include execution commands.

In the description below, even when each function is described simply as being executed or implemented by the processor 11, it may be executed or implemented by the processors 11 and 21 or by the processor 21 alone.

The above-mentioned programs may be supplied to the information processing apparatus 10 or the VR device 20 through a computer-readable information storage medium such as an optical disc, a magnetic disk, or a flash memory or through the Internet or the like.

It is to be noted that all the functions illustrated in FIG. 2 may not necessarily be implemented in the information processing system according to the present embodiment, and functions other than those illustrated in FIG. 2 may be implemented.

The shape model acquisition section 31 acquires a plurality of captured images of an object a pose of which is to be estimated, the images being captured by the imaging unit 26. The shape model acquisition section 31 generates and acquires a 3D shape model of the object from the plurality of captured images. More specifically, the shape model acquisition section 31 extracts, from each of the plurality of captured images, a plurality of feature vectors indicating local features. On the basis of the plurality of feature vectors extracted from the plurality of captured images and corresponding to each other and positions in the captured images where the corresponding feature vectors are extracted, the shape model acquisition section 31 determines 3D positions of points where the corresponding feature vectors are extracted. Then, the shape model acquisition section 31 acquires the 3D shape model of the object on the basis of the 3D positions. Since this method is a publicly known method used also in software that performs what is called SfM (Structure from Motion) or visual SLAM (Simultaneous Localization and Mapping), the detailed description thereof is omitted.

The position/pose estimation section 34 estimates, on the basis of a captured image of the object, a position and a pose of the object in the image. The position/pose estimation section 34 may include a machine learning model for estimating the position and pose (hereinafter referred to as an “estimation model”). The estimation model is trained with training data. When an image is input as input data, the trained estimation model outputs estimation data as an estimation result.

To the trained estimation model, information of the captured image of the object is input, and the estimation model may output, as estimation data for estimating the pose of the object, information indicating positions of a plurality of key points. On the object, a plurality of virtual key points and 3D positions thereof are designated in advance. The position/pose estimation section 34 estimates the position and pose of the object on the basis of the positions of the plurality of key points and the 3D positions of the key points on the object. The position and pose of the object is estimated according to a publicly known algorithm. For example, the position and pose may be estimated according to a solution (e.g., EPnP (Efficient Perspective-n-Point)) to the PNP problem related to pose estimation.

For each of the plurality of key points set on the object, the estimation model may output an image indicating the position of the key point. The estimation model may be provided for each key point. The data output from the estimation model may be, for example, a position image indicating a positional relation (e.g., relative direction) between each point and the key point or a position image in the form of a heat map in which each point represents a probability of presence of the key point. The training data for the estimation model may include a plurality of learning images rendered on the basis of a 3D shape model of a target object and ground truth data indicating the positions of the key points of the object in the learning images.

The position/pose estimation section 34 may input, to the estimation model, an image obtained by processing the image of the object captured by the imaging unit 26. For example, the processed image may be an image of a rectangle circumscribing the target object that is cut out from the captured image, an image in which a region other than the object is masked, or an image in which the object is enlarged or reduced to a predetermined size.

Details of the position/pose estimation section 34 may be as described in the paper “PVNet: Pixel-Wise Voting Network for 6DoF Pose Estimation.”

The learning control section 32 decides key points of the target object on the basis of the 3D shape model of the object, generates learning data, and trains the estimation model with the learning data.

The learning control section 32 may generate a plurality of key points according to the publicly known Farthest Point algorithm, for example. It is sufficient if the number N of key points is an integer equal to or greater than four, for example.

The learning control section 32 generates training data to be used for training of the estimation model, on the basis of positions of the plurality of decided key points, and trains the estimation model with the training data. The training data includes a plurality of learning images rendered on the basis of the 3D shape model of the target object and ground truth data indicating positions of the key points of the object in the learning images.

The learning control section 32 may decide positions of key point candidates in a learning image on the basis of a pose of the rendered object and generate, for each of the key point candidates, a ground truth position image corresponding to the position of the key point candidate. Incidentally, the training data may include learning images captured of the object and position images generated according to the pose of the object in the learning images which is estimated by what is called SfM or visual SLAM.

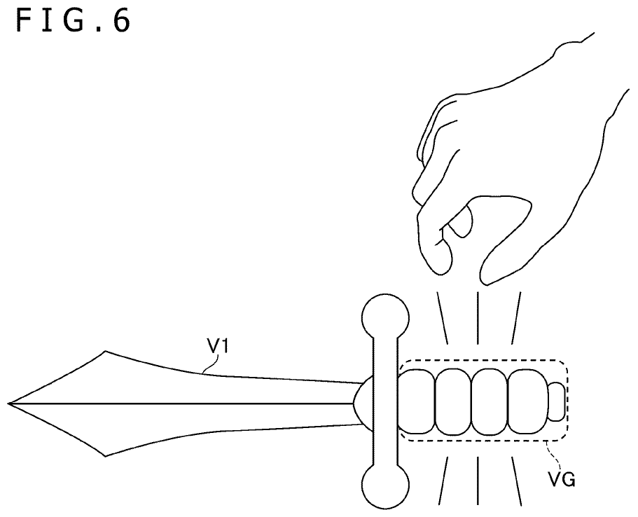

The drawing setting section 33 performs setting such that the object and a virtual item to be displayed in a superimposed manner on the object are displayed in a matched manner. The drawing setting section 33 may set a transformation parameter for use in transforming the position and pose of the object into a position and a pose of the virtual item. In this instance, the drawing setting section 33 may set the transformation parameter such that a portion of the object capable of being held (grip portion RG, see FIG. 5) and a grip portion VG (see FIG. 6) of the virtual item corresponding to the grip portion RG overlap each other.

The grip portion RG of the object may be set in advance by the user or may be estimated by a machine learning model trained on the basis of training data including a shape of the object and the grip portion RG as ground truth. The drawing setting section 33 may transform a vertex of a surface included in a 3D shape model of the virtual item, instead of setting the transformation parameter.

In addition, the drawing setting section 33 sets grip information indicating a portion of the virtual item to be superimposed on the grip portion RG of the object. More specifically, the drawing setting section 33 may acquire and set, as the grip information, information of the grip portion VG of the virtual item set in advance or may acquire and set, as the grip information, information of a portion of the grip portion VG of the virtual item to be superimposed on the grip portion RG of the object. Further, the drawing setting section 33 may update the 3D shape model of the virtual item such that a shape of the grip portion VG of the virtual item corresponds to the shape of the real object.

The hold determination section 35 determines whether or not the user holds the real object.

The drawing section 36 draws the virtual item to be superimposed on the object, on the basis of the position and pose of the object estimated by the position/pose estimation section 34. In addition, the drawing section 36 changes a display mode of a portion (e.g., grip portion VG) of the virtual item to be superimposed on a portion of the object capable of being held. Here, changing the display mode may be drawing the relevant portion of the virtual item in such a manner as to be illuminated (with its color or brightness changed) or may be setting transmittance of the relevant portion of the virtual item greater than that of another portion.

The display decision section 37 included in the drawing section 36 decides a display parameter for drawing the virtual item. The display parameter may be information indicating a display mode of a portion indicated by superimposition information. The display decision section 37 may set (change) the display parameter of the portion of the virtual item indicated by the superimposition information, on the basis of a distance between the user and the virtual item. More specifically, in a case where the distance between the user and the virtual item is equal to or less than a determination threshold, the display decision section 37 may set (change) the display parameter such that the display mode of the portion indicated by the superimposition information is made different from that of another portion.

The display decision section 37 may decide not to draw the virtual item in a case where the distance between the user and the item is more than a drawing threshold. In the case where the distance is more than the drawing threshold, the display decision section 37 may set a display parameter indicating a display mode of the entire virtual item, such that a transmittance of the entire virtual item is greater than that in a case where the distance is equal to or less than the drawing threshold.

The superimposed drawing section 38 draws an image of the virtual item to be superimposed on the object, as a two-dimensional image, on the basis of the display parameter, the estimated position and pose of the object, and information indicating the 3D shape model of the virtual item. Such drawing is also called rendering. In the following description, an image rendered on the basis of the 3D shape model is referred to as a “3D image.” The position and pose of the virtual item to be drawn are adapted to the estimated position and pose of the object by coordinate transformation based on the transformation parameter, for example.

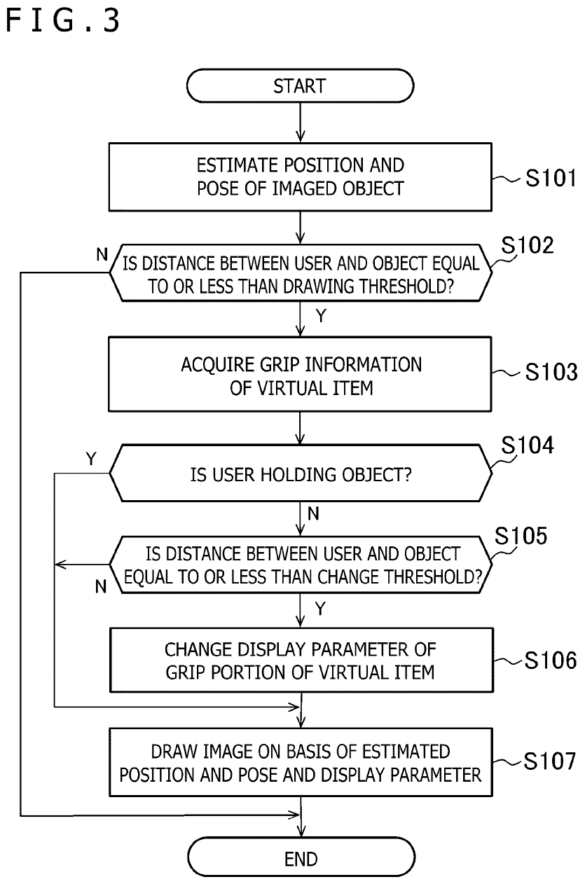

Hereinafter, a process performed by the information processing system is described. FIG. 3 is a flowchart schematically illustrating the process performed by the information processing system. FIG. 3 illustrates a process for displaying a virtual item corresponding to an object. This process is executed by the position/pose estimation section 34, the hold determination section 35, and the drawing section 36. Such processes as training of the estimation model and acquisition of a 3D shape model of the object will be described later.

First, the position/pose estimation section 34 estimates the position and pose of the imaged object from the image (captured image) acquired from the imaging unit 26 (S101). The position/pose estimation section 34 recognizes a rectangular region where the object is present in the captured image by using such a technology as a region proposal, for example, and inputs an image of the rectangular region to the trained estimation model. In response to the input of the image, the estimation model outputs, as information indicating the position and pose of the object, information indicating the positions of key points, for example. The position/pose estimation section 34 estimates the position and pose of the object on the basis of the positions of the key points by using a publicly known technique.

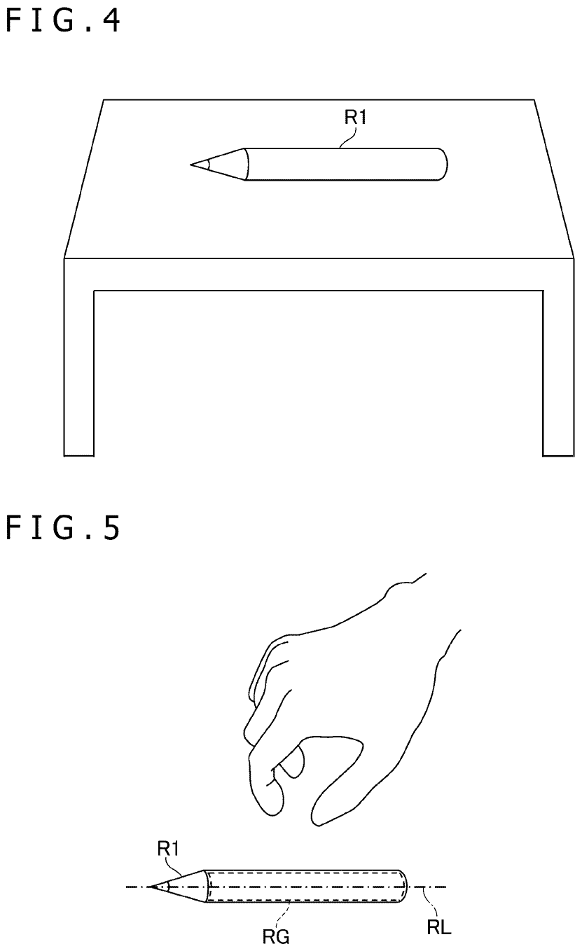

FIG. 4 is a diagram illustrating an example of the captured image. In FIG. 4, a pencil R1 placed on a desk as the object is imaged.

Next, the display decision section 37 included in the drawing section 36 determines whether a distance between the user and the object is equal to or less than the drawing threshold (S102). The position of the user may be any one of a position of the imaging unit 26, a position corresponding to a viewpoint in a virtual space, and a position of a center of the head, for example. The drawing threshold may be a value greater than a change threshold to be described later and may be, for example, approximately 3 m. In a case where the distance is more than the drawing threshold (N in S102), drawing of the object is not performed, and the process of FIG. 4 ends.

In contrast, in a case where the distance is equal to or less than the drawing threshold (Y in S102), the hold determination section 35 acquires the grip information of the virtual item (S103).

FIG. 5 is a diagram for explaining the object and the grip portion RG thereof. FIG. 5 illustrates the pencil R1 as the object with the grip portion RG of the object indicated by a broken line and also illustrates a virtual center line RL of the grip portion RG. The information indicating the grip portion RG may include, for example, information indicating an outer surface of the grip portion RG and may further include information of the center line RL.

After acquiring the grip information, the hold determination section 35 determines whether the user is holding the object (S104). The hold determination section 35 may estimate a hand pose from the captured image by using a publicly known technique and determine whether the user is holding the object, on the basis of the pose.

As the hand pose, coordinates in a 3D space of joints of imaged hand and fingers may be acquired. To acquire the hand pose, a machine learning model that has been trained with images and ground truth data indicating the joints may be used. The images input to the machine learning model may include not only visible images but also depth images. Since the technique of acquiring the hand pose is publicly known, the detailed description thereof is omitted. For example, the hold determination section 35 may determine that the object is held, in a case where the acquired hand pose indicates that the hand is holding something and where a range surrounded by the hand (which range is determined according to positions of the joints) overlaps a position of the grip portion RG indicated by the grip information (e.g., in a case where the center line RL passes through a range surrounded by the hand and fingers)

The determination as to whether the object is held may be made by another method. In a case where a portion of the object to be held has a rectangular cuboid shape, for example, whether the object is held may be determined according to a distance between the object and a fingertip (distance between a vertex of a shape model of the object and a finger joint) instead of using the center line. This technique makes it possible to handle also a case where an edge of the object is pinched and held. Incidentally, there might be a case where it is determined that the object is held, before the holding is actually completed, and where a hindering image is displayed. In this case, however, it is easy to complete the actual holding of the object since the object and the finger are sufficiently close to each other.

In a case where it is determined that the object is held (Y in S104), the display decision section 37 sets the display parameter of the grip portion VG of the virtual item to the same value as an initial value. Since the display parameter of the grip portion VG has been changed before the object is held, the display decision section 37 practically restores the display parameter to an initial state.

In contrast, in a case where it is determined that the object is not held (N in S104), it is determined whether the distance between the user and the object is equal to or less than the change threshold (S105). In a case where the distance is equal to or less than the change threshold (Y in S105), the display decision section 37 changes the display parameter of the grip portion VG of the virtual item to a value different from the initial value (S106). In contrast, in a case where the distance is more than the change threshold (N in S105), the display decision section 37 sets the display parameter of the grip portion VG of the virtual item to the same value as the initial value (or does not change the display parameter from the initial state).

Then, the superimposed drawing section 38 included in the drawing section 36 draws an image of the virtual item to be superimposed on the object, on the basis of the position and pose estimated by the object, the display parameter, and the 3D shape model of the virtual item (S107). Here, the superimposed drawing section 38 draws the grip portion VG of the virtual item in the display mode corresponding to the display parameter.

FIG. 6 is a diagram for explaining drawing of the grip portion VG of the virtual item. In FIG. 6, a sword V1 is drawn as the virtual item, and the grip portion VG of the sword V1 is drawn in such a manner as to be illuminated according to the display parameter.

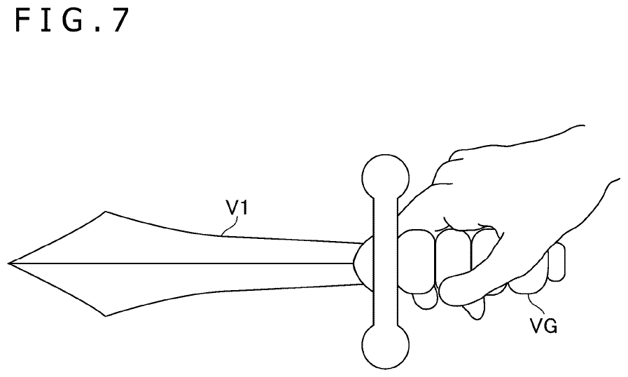

FIG. 7 is a diagram for explaining the virtual item after the object is held. In FIG. 7, the user is holding an object (e.g., pencil R1), and the grip portion VG of the sword V1 as the virtual item is not illuminated. In other words, the grip portion VG is drawn according to the same display parameter as the original initial display parameter.

Incidentally, the virtual item may be drawn also in the case where the distance is more than the drawing threshold in S102. In this case, as the display parameter of the entire virtual item, the display decision section 37 may set the transmittance of the entire virtual item greater than that in a normal state. Further, the superimposed drawing section 38 may draw the virtual item in S107 in such a manner that the transmittance of the entire virtual item is greater than that in its original state.

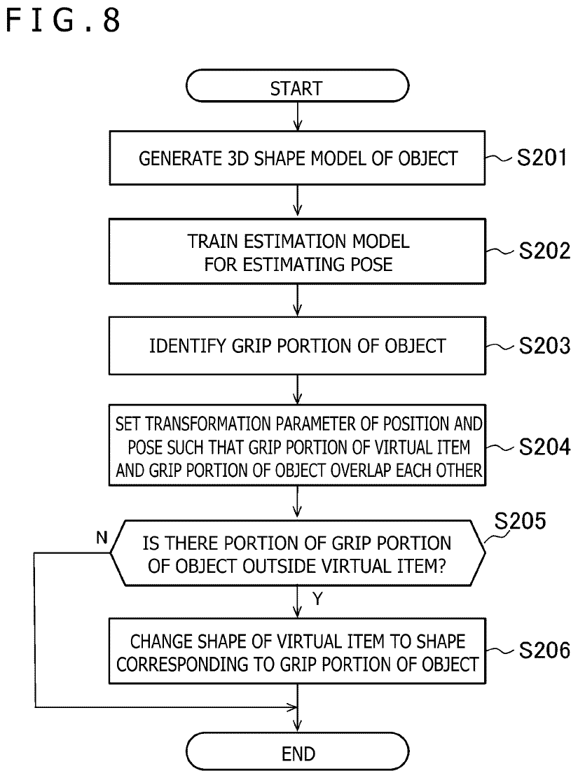

Next, a process performed before the process illustrated in FIG. 3 is described. FIG. 8 is a flowchart illustrating an example of a process for associating the object with the virtual item. First, the shape model acquisition section 31 generates a 3D shape model of an object on the basis of a plurality of captured images of the object by using a publicly known technique (S201).

Then, the learning control section 32 decides positions of key points of the object on the basis of the 3D shape model and trains the estimation model for estimating the pose (S202).

When the estimation model has been trained, the drawing setting section 33 identifies the grip portion RG of the object (S203). The drawing setting section 33 may cause the display unit 14 to display a 3D image of the object, and when the user performs an operation on the 3D image to designate a region, the drawing setting section 33 may acquire the designated region as the grip portion RG. Alternatively, the drawing setting section 33 may input information of the target object to the trained machine learning model for estimating the grip portion RG and identify the grip portion RG according to output from the machine learning model.

After identifying the grip portion RG, the drawing setting section 33 sets the transformation parameter of the position and pose such that the grip portion RG of the object and the grip portion VG of the virtual item corresponding to the object overlap each other (S204). Here, information of the grip portion VG of the virtual item may be set in advance together with the virtual item. As with the object, the information of the grip portion VG of the virtual item may include, for example, information indicating an outer surface of the grip portion VG and may further include information of a center line of the grip portion VG. In this case, the drawing setting section 33 may translate and rotate one of the object and the virtual item such that the center line RL of the grip portion RG of the object and the center line of the virtual item overlap each other and that a distance between respective centers of the grip portions RG and VG is minimized, for example, and may set a parameter related to the translation and rotation as the transformation parameter.

Incidentally, instead of setting the transformation parameter, the drawing setting section 33 may transform, for example, coordinates of a vertex included in the 3D shape model of the virtual item on the basis of the parameter related to the translation and rotation, to thereby match a coordinate system of the object and a coordinate system of the virtual item.

Here, the drawing setting section 33 may update the grip information indicating the grip portion VG of the virtual item. The drawing setting section 33 may set, as new grip information, information indicating a portion that is included in the grip portion VG indicated by the grip information of the virtual item set in advance and that is superimposed on the grip portion RG of the object when viewed in a direction along the center line. By performing this processing, the drawing setting section 33 can delete a portion of the grip portion VG of the virtual item protruding from the grip portion RG of the object and reduce a possibility that the user will hold a portion of the object incapable of being held.

After setting the transformation parameter, the drawing setting section 33 determines whether there is a portion of the grip portion RG of the object outside the virtual item (S205). For example, the drawing setting section 33 may cast a ray from the center line RL toward a vertex of a surface of the virtual item in a direction perpendicular to the center line. In a case where the ray intersects a surface of the object beyond the surface of the virtual item, the drawing setting section 33 may determine that the relevant portion of the object is outside the virtual item. This determination may be made for each vertex constituting the surface of the virtual item.

In a case where there is a portion of the grip portion RG of the object outside the virtual item (Y in S205), the drawing setting section 33 changes the shape of the grip portion VG of the virtual item to a shape corresponding to the grip portion RG of the object (S206). Specifically, for example, in the case where a ray intersects the surface of the object beyond the surface of the virtual item, the drawing setting section 33 may replace coordinates of the relevant vertex of the surface of the virtual item with coordinates corresponding to the point where the ray intersects the object.

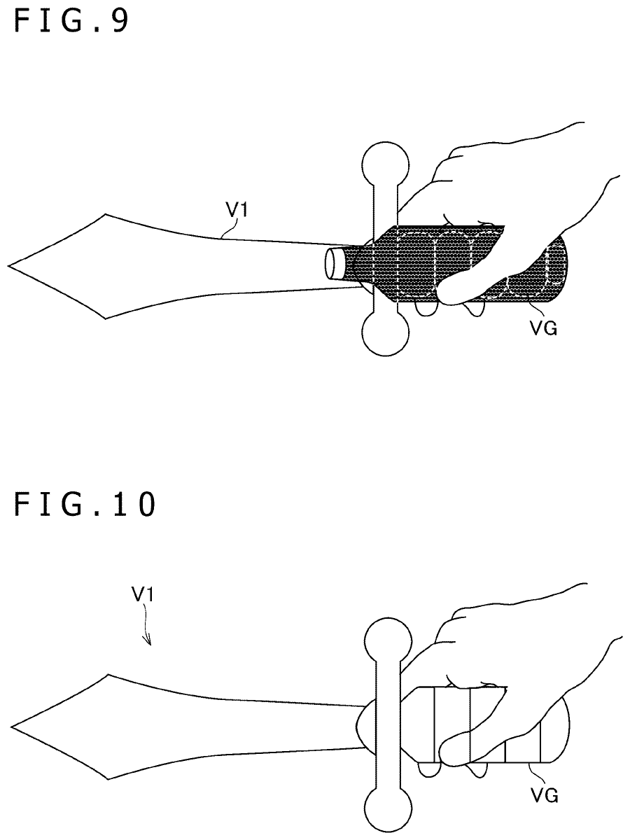

FIG. 9 is a diagram illustrating an example of the object protruding from the virtual item. In the example of FIG. 9, a plastic bottle R2 is used as the object and has a grip portion RG thicker than and protruding from the sword V1 as the virtual item.

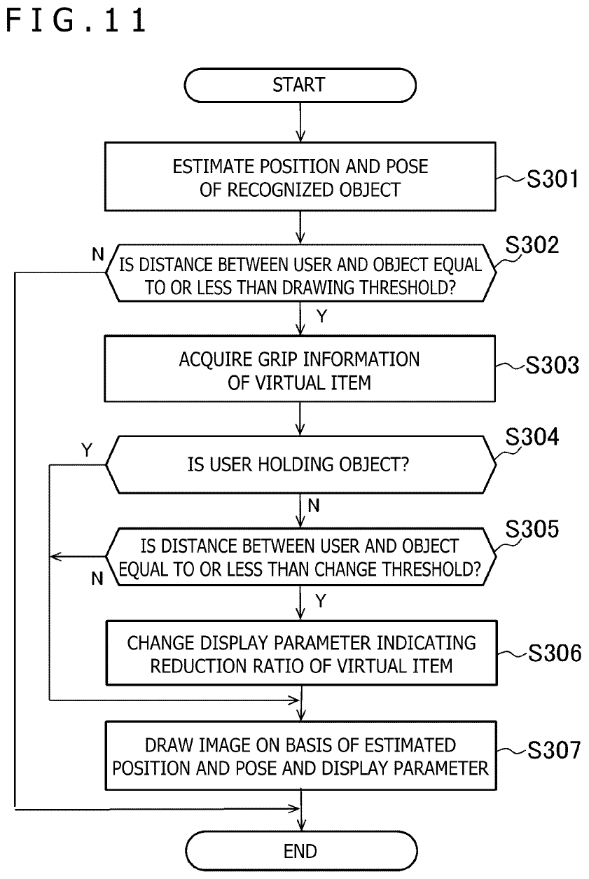

FIG. 10 is a diagram illustrating an example of a changed shape of the virtual item. The diagram of FIG. 10 corresponds to FIG. 9. In the example of FIG. 10, through such processing as illustrated in S205 and S206, the shape of the grip portion VG of the sword V1 becomes thicker than the shape illustrated in FIG. 6 and corresponds to the shape of the grip portion RG of the object.

In the case where the grip portion RG of the object is larger than the virtual item, the grip portion VG of the virtual item is enlarged. This can suppress such an unnatural situation that the virtual item displayed after the user holds the object makes the hand of the user invisible.

Further, the user can intuitively hold the object. This is because the shape of the grip portion VG of the virtual item approximates to the shape of the grip portion RG of the object as illustrated in the example of FIG. 10.

Here, in a case where the grip portion RG of the object is thinner than the virtual item, a size of the virtual item to be drawn in a superimposed manner may be reduced. FIG. 11 is a flowchart illustrating another example of the process of drawing the virtual item corresponding to the object and is a diagram for explaining a process which is a modified example of the process illustrated in FIG. 3. The detailed description overlapping the description of the process of FIG. 3 is omitted below.

First, the position/pose estimation section 34 estimates the position and pose of the imaged object from the image (captured image) acquired from the imaging unit 26 (S301). Next, the display decision section 37 included in the drawing section 36 determines whether the distance between the user and the object is equal to or less than the drawing threshold (S302). In a case where the distance is more than the drawing threshold (N in S302), drawing of the virtual item is not performed, and the process of FIG. 11 ends. In contrast, in a case where the distance is equal to or less than the drawing threshold (Y in S302), the hold determination section 35 acquires the grip information of the virtual item (S303). The processing of S301 to S303 is similar to the processing of S101 to S103 in FIG. 3.

After acquiring the grip information, the hold determination section 35 determines whether the user is holding the object (S304). In a case where it is determined that the object is held (Y in S304), the display decision section 37 sets the display parameter of the grip portion VG of the virtual item to the same value as the initial value.

In contrast, in a case where it is determined that the object is not held (N in S304), it is determined whether the distance between the user and the object is equal to or less than the change threshold (S305). In a case where the distance is equal to or less than the change threshold (Y in S305), the display decision section 37 changes a display parameter indicating a reduction ratio of the virtual item (S306). The reduction ratio may be decided on the basis of a ratio between the maximum value of a diameter of the grip portion RG of the object and the minimum value of a diameter of the grip portion VG of the virtual item, for example. The diameter of the grip portion RG of the object may be calculated by, for example, determining points where a plurality of lines that individually pass through a plurality of points on the center line RL and that are perpendicular to the center line RL intersect the surface of the object. The diameter of the grip portion VG of the virtual item may be calculated by a similar technique.

In contrast, in a case where the distance is more than the change threshold (N in S305), the display decision section 37 sets the display parameter indicating the reduction ratio of the virtual item to the same value as an initial value (e.g., 100%).

Then, the superimposed drawing section 38 included in the drawing section 36 draws an image of the virtual item to be superimposed on the object, on the basis of the position and pose estimated by the object, the display parameter, and the 3D shape model of the virtual item (S307). Here, the superimposed drawing section 38 draws the virtual item in the reduction ratio corresponding to the display parameter.

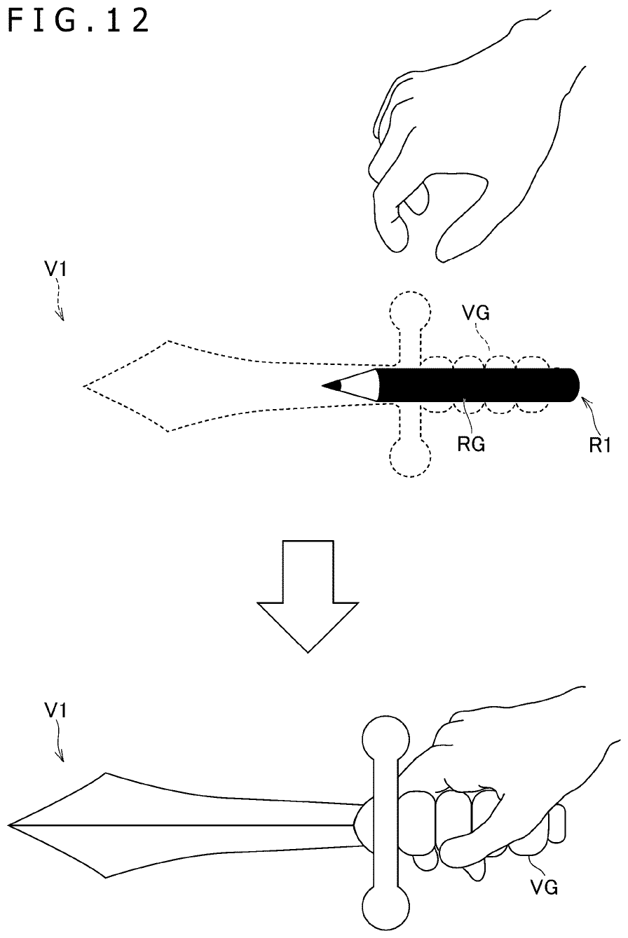

FIG. 12 is a diagram for explaining the virtual item that is reduced in size before the object is held. On an upper side of FIG. 12, the sword V1 drawn as the virtual item by the superimposed drawing section 38 is illustrated. While the sword V1 is indicated by a broken line on the upper side of FIG. 12, a 3D image that is rendered to have transmittance of 0% may actually be drawn. Here, the sword V1 is drawn in a reduced size such that the grip portion VG of the sword V1 has substantially the same diameter as the grip portion RG of the pencil R1 as the object.

Meanwhile, on a lower side of FIG. 12, the sword V1 after the object is held is illustrated. The sword V1 on the lower side of FIG. 12 is illustrated as the virtual item (sword V1 herein) when the user holds the object (e.g., pencil R1). This sword V1 is not reduced in size, so that it is larger than that on the upper side.

In this way, the size of the grip portion VG of the virtual item before the object is held is approximated to the size of the real object, so that it becomes easier for the user to intuitively recognize the grip portion RG of the object. Accordingly, the user can easily hold the object.

Here, the process of FIG. 3 and the process of FIG. 11 may be combined. That is, the display decision section 37 may change in S306 not only the reduction ratio of the entire virtual item before the object is held but also the display parameter indicating the display mode of the grip portion VG of the virtual item, and the superimposed drawing section 38 may draw the virtual item that has been reduced in size before the object is held and for which the display mode of the grip portion VG has been changed.

It is to be noted that the specific numerical values described above and the objects and numerical values in the drawings are illustrative, and the values and objects are not limited to these examples and may be modified as needed

1. An information processing system comprising:
a memory comprising computer-executable instructions; and
a processor configured to access the memory and execute the computer-executable instructions to perform operations comprising:
estimating a position and a pose of a real object from a captured image of the real object;
drawing a virtual item to be superimposed on the real object, on a basis of the estimated position and pose; and
changing, in the drawing, a display mode of a portion of the item to be superimposed on a portion of the real object capable of being held.

2. The information processing system according to claim 1, wherein the memory comprises additional computer-executable instructions and the processor is further configured to access the memory and execute the additional computer-executable instructions to perform additional operations comprising drawing a three-dimensional image of the virtual item to be superimposed on the real object, on a basis of the estimated position and pose and a three-dimensional shape model of the item.

3. The information processing system according to claim 1, wherein the memory comprises additional computer-executable instructions and the processor is further configured to access the memory and execute the additional computer-executable instructions to perform additional operations comprising:
determining whether or not a user holds the real object, and
restoring the display mode of the portion to be superimposed to its original state in a case of determining that the user holds the real object.

4. The information processing system according to claim 1, wherein the memory comprises additional computer-executable instructions and the processor is further configured to access the memory and execute the additional computer-executable instructions to perform additional operations comprising changing the display mode of the portion to be superimposed, on a basis of a distance between a user and the item.

5. The information processing system according to claim 4, wherein the memory comprises additional computer-executable instructions and the processor is further configured to access the memory and execute the additional computer-executable instructions to perform additional operations comprising making the display mode of the portion to be superimposed different from a display mode of another portion in a case where the distance between the user and the item is equal to or less than a determination threshold.

6. The information processing system according to claim 1, wherein the memory comprises additional computer-executable instructions and the processor is further configured to access the memory and execute the additional computer-executable instructions to perform additional operations comprising drawing the item in such a manner that the portion to be superimposed is illuminated.

7. The information processing system according to claim 1, wherein the memory comprises additional computer-executable instructions and the processor is further configured to access the memory and execute the additional computer-executable instructions to perform additional operations comprising drawing the item in such a manner that transmittance of the portion to be superimposed is greater than transmittance of another portion.

8. The information processing system according to claim 1, wherein the memory comprises additional computer-executable instructions and the processor is further configured to access the memory and execute the additional computer-executable instructions to perform additional operations comprising, in a case where a distance between a user and the item is more than a drawing threshold, not drawing the item, or set transmittance of the item greater than transmittance of the item in a case where the distance is equal to or less than the drawing threshold.

9. The information processing system according to claim 1, wherein the memory comprises additional computer-executable instructions and the processor is further configured to access the memory and execute the additional computer-executable instructions to perform additional operations comprising drawing the item in such a manner that a shape of the portion to be superimposed corresponds to a shape of the real object.

10. A computer-implemented method comprising:
estimating a position and a pose of a real object from a captured image of the real object;
drawing a virtual item to be superimposed on the real object, on a basis of the estimated position and pose;
acquiring information indicating a portion of the item to be superimposed on a portion of the real object capable of being held; and
changing, in the drawing, a display mode of the portion to be superimposed that is indicated by the information.

11. One or more non-transitory computer-readable media comprising computer-executable instructions that, when executed by one or more processors of an electronic device, cause the electronic device to perform operations comprising.
estimating a position and a pose of a real object from a captured image of the real object;
drawing a virtual item to be superimposed on the real object, on a basis of the estimated position and pose;
acquiring information indicating a portion of the item to be superimposed on a portion of the real object capable of being held; and
changing, in the drawing, a display mode of the portion to be superimposed that is indicated by the information.
